(19) United States
(12) Patent Application Publication
(10) Pub. No.: US 2025/0007666 A1
(43) Pub. Date: Jan. 2, 2025

(54) METHODS AND SYSTEMS FOR SYNCHRONIZATION ENHANCEMENT IN NEW RADIO NON-TERRESTRIAL NETWORKS

(71) Applicant: InterDigital Patent Holdings, Inc., Wilmington, DE (US)

(72) Inventors: Allan Tsai, Boonton, NJ (US); Patrick Svedman, Stockholm (SE); Kyle Pan, Saint James, NY (US); Pascal Adjakple, Great Neck, NY (US); Jerome Vogedes, Milwaukee, WI (US); Yifan Li, Conshohocken, PA (US); Guodong Zhang, Woodbury, NY (US)

(73) Assignee: InterDigital Patent Holdings, Inc., Wilmington, DE (US)

(21) Appl. No.: 18/704,358

(22) PCT Filed: Nov. 8, 2022
(86) PCT No.: PCT/US2022/079473

§ 371 Date: Apr. 24, 2024

Related U.S. Application Data
(60) Provisional application No. 63/276,874, filed on Nov. 8, 2021.

(51) Int. Cl. H04L 5/00; H04W 56/00; H04W 72/1268; H04W 74/0836; H04W 84/06

(52) U.S. Cl. CPC H04L 5/0051; H04W 56/0045; H04W 72/1268; H04W 74/0836; H04W 84/06

(57) ABSTRACT

Methods and apparatuses are described herein for synchronization enhancement in new radio non-terrestrial networks. In an example. a UE may determine a distance between the UE and a satellite of a NTN. The UE may determine a reference distance associated with the satellite. The UE may determine a differential delay associated with the UE based on the distance between the CE and the satellite and based on the reference distance. Based on the differential delay. the UE may determine a timing advance associated with the UE and the NTN.

### CROSS-REFERENCE TO RELATED APPLICATIONS

This application claims the benefit of U.S. patent application Ser. No. 63/276,874, filed Nov. 8, 2021.

### BACKGROUND

In non-terrestrial networks (NTNs), support for synchronization of the transmission timing of data streams among user apparatuses (UEs) and the network may face issues absent in terrestrial networks. For example, in NTNs, the propagation delays associated with UEs in communication with airborne or spaceborne platforms, in addition to the size of a cell served by the platforms, may cause problems associated with initially joining and with maintaining a connection to an NTN. Accordingly, there is a need for improved synchronization of UEs with NTNs.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods and apparatuses are described herein for synchronization enhancement in new radio (NR) NTNs. System enhancements may improve synchronization for UEs attempting to join NTNs, even in situations where UEs do not have access to the UEs location. Systems and methods described herein may provide a UE with the ability to estimate a timing advance to apply to the UE based on the UE's location. System enhancements may be further provided to support UE estimation of a round trip time associated with communicating with the NTN in the absence of location information. Additionally, systems and methods may be provided to enhance multi-connectivity of a UE on both a terrestrial network (TN) and a NTN simultaneously.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system.

FIG. 2 shows an example system.

FIG. 3 shows an example system.

FIG. 4A shows an example system.

FIG. 4B shows an example system.

FIG. 5 shows an example method.

FIG. 6 shows an example method.

FIG. 7 shows an example method.

FIG. 8 shows an example system.

FIG. 9 shows an example system.

FIG. 10 shows an example system.

FIG. 11A shows an example system.

FIG. 11B shows an example system.

FIG. 12 shows an example system.

FIG. 13A shows an example communications system.

FIG. 13B shows an example apparatus configured for wireless communications.

FIG. 13C shows an example system.

FIG. 13D shows an example system.

FIG. 13E shows an example system.

FIG. 13F shows an example system.

FIG. 13G shows an example system.

### DETAILED DESCRIPTION

Methods and apparatuses are described herein for synchronization enhancement in new radio non-terrestrial networks.

The following abbreviations and definitions may be used herein:

| | |
|---|---|
| A/N | Ack/Nack |
| AOA | Angle of Arrival |
| AS | Access Stratum |
| BCCH | Broadcast Control Channel |
| BCH | Broadcast Channel |
| BWP | BandWidth Part |
| CC | Component Carrier |
| CE | Control Element |
| CCE | Control Channel Elements |
| CORESET | Control Resource Set |
| CP | Cyclic Prefix |
| CRI | CSI-RS Resource Indicator |
| CRC | Cyclic Redundancy Check |
| C-RNTI | Cell Radio-Network Temporary Identifier |
| CSI | Channel State Information |
| DC | Dual Connectivity |
| DCI | Downlink Control Information |
| DD | Differential Delay |
| DL | Downlink |
| E-SLMC | Evolved Serving Mobile Location Center |
| FR1 | Frequency Range 1 |
| FR2 | Frequency Range 2 |
| FRF | Frequency Reuse Factor |
| GEO | Geostationary Earth Orbiting |
| GNSS | Global Navigation Satellite System |
| GP | Guard Period |
| HAPS | High Altitude Platform Station |
| IE | Information element |
| ISI | Inter-Symbol Interference |
| LEO | Low Earth Orbit |
| LMF | Location Management Function |
| LPP | LTE Positioning Protocol |
| LTE | Long term Evolution |
| MAC | Medium Access Control |
| MC | Multi connectivity |
| MEO | Medium Earth Orbit |
| MgNB | Master-gNB |
| MIMO | Multiple-Input Multiple-Output |
| MPL | Maximum Path Loss |
| M-TRP | Multiple Transmit Receive Point |
| NACK | Non-ACKnowledgement |
| NR | New Radio |
| NR-DRS | NR Reference signal in Downlink (typically |
| | used for channel estimation) |
| NTN | Non-Terrestrial Network |
| RS | Reference Signal |
| RSRP | Reference Signal Received Power |
| OFDM | Orthogonal frequency division multiplexing |
| PCI | Physical Cell ID |
| PDCCH | Physical Downlink Control Channel |
| PDSCH | Physical Downlink Shared Data Channel |
| PUSCH | Physical Uplink Shared Channel |
| PRACH | Physical Random Access Channel |
| PRB | Physical Resource Block |
| PRS | Positioning Reference Signal |
| QCL | Quasi-CoLocation |
| RAN | Radio Access Network |
| RAR | Random Access Response |
| RAT | Radio Access Technology |
| RB | Resource block |
| RE | Resource Element |
| RNTI | Radio Network Temporary Identifier |
| RO | RACH Occasion |
| RRC | Radio Resource Control |
| RTT | Round Trip Time |
| SCS | SubCarrier Spacing |
| SFN | Single Frequency Network |
| SgNB | Secondary-gNB |
| SI | System Information |
| SIB | System Information Block |
| SI-RNTI | System Information RNTI |
| SPS-RNTI | Semi persistent scheduling RNTI |
| SR | Scheduling Request |
| SRI | SRS Resource Indicator |
| SRS | Sounding Reference Signal |
| SS | Search Space |
| SSB | Synchronization Signal Block |
| TA | Timing Advance |
| TAC | Timing Adjustment Command (TAC) |
| TCI | Transmission configuration indication |
| TDD | Time Division Duplex |
| TN | Terrestrial Network |
| TOA | Time of Arrival |
| TDOA | Time Difference of Arrival |
| TRP | Transmission and Reception Point |
| TRS | Tracking Reference Signal |
| UE | User Equipment |
| UCI | Uplink Control Information |
| UL | Uplink |
| WI | Work Item |

For terrestrial networks (TN), propagation delays are usually less than 1 ms. However, in Non-Terrestrial Networks (NTN) systems, propagation delays may range from several milliseconds to hundreds of milliseconds depending, for example, on the altitudes of spaceborne or airborne platforms and architecture type (e.g., transparent or regenerative architecture). In NTN, a UE may be required to estimate the Round Trip Time (RTT) and apply a timing advance (TA) value that leads to a large offset in its DL and UL frame timing. The large differential delay (DD) may be experienced by two UEs within the same cell as shown in Error! Reference source not found., which illustrates the differential TA in NTN.

In Release 17 (Rel-17) of the 3rd Generation partnership Project (3GPP), a UE with Global Navigation Satellite System (GNSS) capabilities may obtain its position and the NTN may broadcast its ephemeris via system information (SI). Therefore, the UE may calculate a relative speed between the UE and a satellite, as well as the RTT between the UE and the satellite. The relative speed and the RTT may be used to enhance the TA estimation and perform TA pre-compensation at the UE side thereby minimizing the amount of signaling overhead that may otherwise be required for frequent TA updates, especially in LEO systems. In addition, the UE may use GNSS-based frequency synchronization i.e. GNSS based positioning and Doppler shift estimation in downlink and uplink (based on broadcasted satellite ephemeris data for e.g. satellite's position and velocity) for accurate frequency estimation, and pre-compensation of potential frequency estimation inaccuracies during UL transmissions. Thus, initial access and connected mode time/frequency tracking may need to target a range of residual errors in frequency and time estimation. More specifically, for TA pre-compensation estimation, the UE may use the satellite's position and velocity information acquired from the broadcasted satellite ephemeris data to calculate the corresponding RTT thus allowing the UE to estimate TA pre-compensation and apply such compensation for uplink transmissions during a RACH procedure, thus a NR RACH procedure may not need modifications in Rel-17 NTN.

In Rel-17 NTN, the TA may be categorized as the cell specific common TA and the user-specific (differential) TA, where the former is used to compensate for the round-trip delay at a reference point within the cell/beam, e.g., the nearest point to the satellite, and the latter may be used to represent the difference between the common TA and the actual TA for a specific user. The common TA may be obtained by UEs via broadcast information (i.e., SI) from the satellite and the differential TA may be estimated by the UE while the UE's position and the satellite's ephemeris information are available. The residual TA may be adjusted for the transmission of the Random Access Response (RAR) message or the random access procedure completion message, i.e., Msg5 (message 5) in a 4-step RACH procedure or the equivalent in a 2-step RACH procedure, thus the UE may be synchronized with the NTN network.

In Rel-17 RANI NTN agreement, in the case of a GNSS-assisted TA acquisition in RRC idle and/or inactive states, the UE may calculate its TA based on one or more conditions.

One condition may indicate that NTN UE in RRC_IDLE and RRC_INACTIVE states are required to at least support UE specific TA calculation based at least on its GNSS-acquired position and the serving satellite ephemeris. The user specific TA may be estimated by the UE based on the UE's GNSS acquired position together with the serving satellite ephemeris indicated by the network.

Another condition may indicate that an NTN UE in RRC_IDLE and RRC_INACTIVE states shall be capable of at least using the UE's acquired GNSS position and satellite ephemeris to calculate frequency pre-compensation to counter a Doppler shift experienced on the service link.

Another condition may indicate that an NTN UE in RRC_CONNECTED state may be required to support UE specific TA calculation based at least on its GNSS-acquired position and the serving satellite ephemeris.

Another condition may indicate that the starts of ra-Response Window (upon determining a RACH preamble transmission, the UE may monitor a PDCCH and wait for an RA response within an RA response window) for a 4-step RACH procedure and msgB-Response Window (upon determining a MsgA transmission, the UE may monitor for a response from the network within a configured window) for a 2-step RACH procedure may be delayed by an estimate of UE-gNB RTT.

Another condition may indicate that the estimate of the UE-gNB RTT may be equal to the sum of the UE's TA and Kmac.

Another condition may indicate that the user specific TA may be estimated by the UE based on one or more of a plurality of criteria, comprising: option 1: The User specific TA may be estimated by the UE based on its GNSS acquired position together with the serving satellite ephemeris indicated by the network, and option 2: The User specific TA may be estimated by the UE based on the GNSS acquired reference time at the UE together with a reference time as indicated by the network.

Based on the RAN1 #104bis-e agreement on Timing Advance, the UE's TA may be expressed by the following factors: T_{TA}= (N_{TA}+N_{TA,UE-specific}+N_{TA,common}+N_{TA,offset})×T_{c}. The N_{TA} may be defined as 0 for a PRACH and updated based on TA Command field in msg2/msgB and MAC CE TA command. In NR, TA command may be one of MAC CE payload in msg2/msgB. The N_{TA,UE-specific} may be a UE self-estimated TA to pre-compensate for the service link delay. The N_{TA,common} may be a network-controlled common TA and may comprise any timing offset considered necessary by the network. The N_{TA,common} with a value of 0 may be supported. The N_{TA,offset} may be a fixed offset used to calculate the timing advance. The estimate of a gNB-satellite RTT may be equal to the sum of N_{TA,common}×T_{c} and K_{mac}. When the UE is not provided by the network with a K_{mac} value, the UE may assume K_{mac}=0.

Another parameter related to RTT:

$${K}_{offset} = ⌈ \frac{RTT}{slot duration} ⌉ ,$$

or K_{offset} may be interpreted as the RTT duration in terms of OFDM slots. Using K_{offset} may modify the relevant timing relationships, for example any one or more of the transmission timing of DCI scheduled PUSCH, the transmission timing of RAR grant scheduled PUSCH, the transmission timing of HARQ-ACK on PUCCH, the CSI reference resource timing, and the transmission timing of aperiodic SRS.

In NR, two protocols may be used to exchange location information. First, the NR extension of the LTE Positioning Protocol (LPP) may cover signaling between UE and the positioning server, e.g., Location Management Function (LMF) or Secure User Plane Location (SUPL) Location Platform (SLP). Second, the Radio Resource Control (RRC) protocol may transport the LPP messages over the NR-Uu interface to the target UE. In NG-RAN the gNB and ng-eNB are the base stations that receive the positioning requests from LMF, provide positioning related measurement information to a target UE, perform the uplink positioning measurements and handle the signaling between NR-RAN and LMF in CN. An exemplary illustration of protocol layering between signaling between an LMF and a UE is illustrated in the Error! Reference source not found . . .

In Rel-16, a PRS footprint on a time-frequency grid may be configurable with a starting physical resource block (PRB) and a PRS bandwidth. The PRS may start at any PRB in the system bandwidth and may be configured with a bandwidth ranging from 24 to 276 PRBs in steps of 4 PRBs. This amounts to a maximum bandwidth of about 100 MHz for 30 kHz SCS to about 400 MHz for 120 KHz SCS.

Rel-16 TN may support various multi connectivity such as EN-DC (E-UTRA-NR Dual Connectivity), NR-DC (New Radio Dual Connectivity), NGEN-DC (NG-RAN-E-UTRA Dual Connectivity) and NE-DC (NR-E-UTRA Dual Connectivity). Packet duplication (PD), in which the same packets are sent from the different nodes, may be supported. Reliability may be increased due to the use of multiple redundant links. Thus, latency may be reduced with the elimination of packet re-transmission and the immediate processing of packets. Overall, PD may reduce the frequent handover, may improve mobility robustness, and may reduce the probability of radio link failure (RLF) as the packets are available at both nodes. However, such gains may be obtainable at the expense of throughput loss due to increased traffic load resulting from duplication of packets and certain requirements of timing synchronization.

Similarly, one aim of NTN with multi connectivity (MC) may be to exploit the diversity of the simultaneous connection to different communication nodes in meeting system performance requirements. Using MC, three main types of diversity may be exploited: spatial diversity, frequency diversity, and radio access technology (RAT) diversity. There are four possible NTN with MC: 1) Multi connectivity involving transparent NTN-based NG-RAN and cellular/TN NG-RAN as shown in Error! Reference source not found. 2) Multi connectivity between two transparent NTN-based NG-RAN (e.g., gNB is not on board). 3) Multi connectivity involving regenerative NTN-based NG-RAN (gNB-DU) and cellular/TN NG-RAN. 4) Multi connectivity between two regenerative NTN-based NG-RAN (e.g., gNB on board).

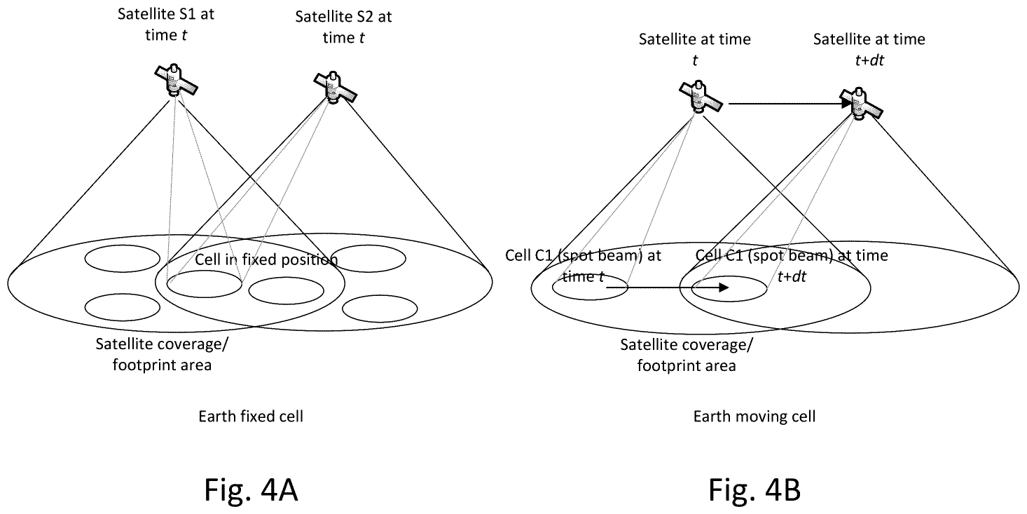

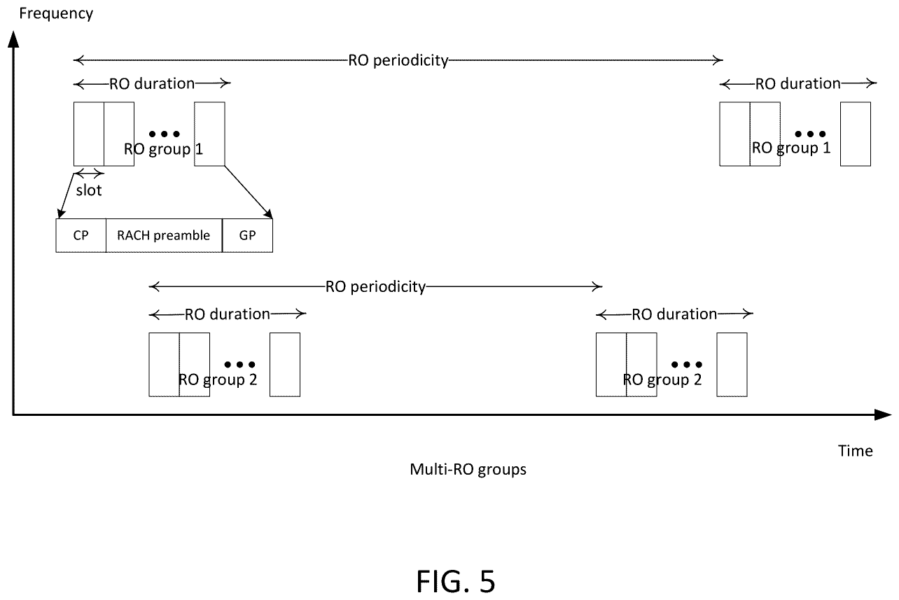

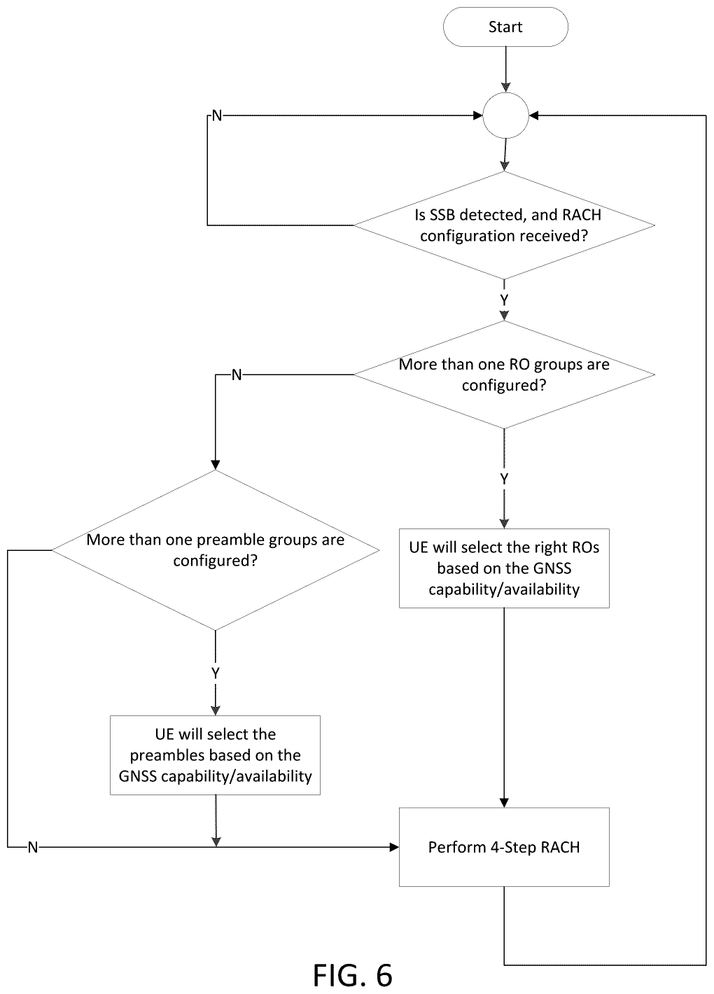

NR NTN may support at least two deployment scenarios for the satellite cells, i.e., earth fixed cell and earth moving cell as shown in Error! Reference source not found.A and FIG. 4B respectively. For the earth fixed cell (or quasi-Earth fixed cell) deployment, earth fixed cells may assume that the cells are fixated to a certain location on Earth from the time where the satellite (these cells belong to), may be at a certain elevation angle over the horizon until the same satellite has reached the same elevation angle at the opposite horizon (e.g., LEO/MEO with steerable beams). On the other hand, for the earth moving cell or earth moving beam deployment, the serving spot beam may change from time to time and assume that the cells follow the satellite coverage. There are two agreed options in NR Rel-17 work item (WI) for mapping of physical cell index (PCI) and SSB to satellite (spot) beam in NR NTN: Option-a: multiple satellite spot beams per PCI with SSB. Option-b: one satellite spot beam per PCI.

In Rel-17, NTN access with accurate frequency and time synchronization may only be provided to UEs that have already acquired location based on GNSS. Due to this limitation, NTN coverage may be limited to outdoor users. For UEs without GNSS capabilities or in an environment with GNSS signal degradation, the location estimation and Doppler compensation may be poor, thus impacting the time-frequency synchronization and the accuracy of frequency estimate, frequency pre-compensation for uplink transmissions, as well as TA estimate and TA pre-compensation. The impacted areas may comprise time and frequency synchronization, frequency and Doppler estimation, TA estimation, random access procedure/signals, reception quality in part due to excessive intra-cell inter-symbol interference, and mobility handling, or the like.

In Rel-17, a UE may need to decide the start offset of ra-ResponseWindow for a 4-step RACH or msgB-response Window for a 2-step RACH. The starts of ra-Response Window for a 4-step RACH procedure and msgB-ResponseWindow for a 2-step RACH procedure may be delayed by an estimate of the UE-gNB RTT. If the UE lacks location information, accurate RTT may not be computed to aid in determining the start offset of the ra-ResponseWindow in case a 4-step RACH may be performed and msgB-Response Window in case a 2-step RACH may be performed.

The UE's TA may be based on the Rel-17 RANI agreement on Timing Advance applied by an NR NTN UE given by T_{TA}=(N_{TA}+N_{TA,UE-specific}+N_{TA,common}+N_{TA,offset})×T_{c}. If the UE specific TA factor (i.e., N_{TA,UE-specific}) in T_{TA} cannot be estimated, the estimation of UE-specific TA may be poor thus hampering the system performance and may generate unwanted interference caused by imperfect timing synchronization. Therefore, some methods are needed to support NTN UE TA and/or RTT estimation if the UE cannot obtain its position based on GNSS.

In Rel-17, an NTN UE may not be required to connect to both TN and NTN at the same time. For Rel-18 and beyond, an NTN UE with multi-connectivity may be highly desirable. For a UE without GNSS information in NTN, the NTN coverage may be limited, for example if the NTN UE is indoor. Therefore, if other connections can assist the UE for the determination of the NTN's position, e.g., a satellite's position, the time synchronization issue for an NTN UE without GNSS may be resolved. Similarly, if other connections can assist the UE for the determination of the NTN's position and velocity, e.g., a satellite's position and velocity, the frequency synchronization issue for an NTN UE without GNSS may be resolved.

Solutions for synchronization of NR NTNs are presented herein. In one solution, the following enhanced synchronization methods for NR NTN without GNSS information is proposed: the UE behaviour for UE with/without GNSS capability and/or availability, comprising one or more of separated RO groups for UEs with or without GNSS capability and/or availability and partitioned (PRACH) preamble for the indication of a UE with or without GNSS capability and/or availability; multi-beam per cell and each beam footprint may be constrained by a limit by the satellite footprint and common TA may be associated to one or more SSBs; NTA,UE-specific estimation in TA methods for UE without GNSS capability and/or availability, comprising one or more of: satellite range for the differential delay and UE-specific TA estimation and satellite positioning.

In another solution, the following methods for NR NTN synchronization are proposed: methods for UE behaviors to handle NTN MC synchronization for a UE without GNSS capability/availability; the UE may acquire its position from other connectivity (e.g., TN) to assist an NTN UE without GNSS. For example, the UE may perform either a 4-step or a 2-step RACH procedure and the UE may enter the RRC_CONNECTED state for requesting the UE positioning from TN. Upon obtaining the UE position from the TN system, the UE may perform UE-specific TA estimation with the received satellite ephemeris information at the epoch time t₀, and the UE may perform the RACH procedure and indicate the network that the UE position may be provisioned from the TN. Further description and explanation of the problems discussed above are presented herein.

NR NTN may support UEs that have GNSS, non-GNSS capabilities and GNSS signal degradation. In Rel-17, it has been agreed to use differential delay and GNSS assisted information for the UE to estimate UE-specific TA, thus the UE may pre-compensate for residual TA error due to excessively large differential delay between UEs within the same cell.

For a UE without location information, broadcasting a common TA for NTN or extending the value range of the existing TA offset that may be broadcasted in system information as Rel-17 may be a baseline for initial timing advance during a random access procedure in NTN. However, compensating for the common TA may not be sufficient for some NTN deployment scenarios. For example, for a LEO satellite with coverage 200 km and altitude 600 km, the maximum differential delay is approximately 0.654 ms, and for a GEO satellite with coverage 500 km, the maximum differential delay is approximately 1.63 ms, respectively.

To avoid inter-symbol interference (ISI) during preamble transmission, the differential delay of signal propagation among the UEs should be less than the cyclic prefix (CP) and guard period (GP) length of the preamble. Also, timing error due to satellite drifting in time, etc. should also be considered in the designs of PRACH CP and GP.

By extending the PRACH format design, TA calculation and signalling adaptation to deal with the maximum differential delay in various NTN scenarios (LEO, MEO, GEO, and HAPS, and the like) for UEs without GNSS location information may be resolved.

In NR, legacy PRACH long formats 0, 1, 2 and 3 are listed in Error! Reference source not found. Different long RACH formats may support different propagation delays and the preamble format selected should have a CP duration equal to or greater than the maximum differential delay. In NR, the PRACH preamble length may be expressed as multiple of 24576 κ×T_{seq}. Note (κ=64) and T_{seq}=0.509×10⁻⁶ ms in NR. Thus, 30720 κ is equal to 1 ms. An exemplary long PRACH long format (e.g., format 4) is listed in in Error! Reference source not found. In this example, the PRACH duration (including GP) is equal to 4 ms for format 4, the PRACH preamble duration is set to 3×24576 κ×T_{seq}=2.784 ms and the CP duration is set to 24524 κ which is around 0.8 ms. Table 1 describes existing PRACH long (preamble) formats 0-3and the proposed long format 4.

TABLE 1

| | SCS | Cyclic Prefix | Guard Period |
|---|---|---|---|
| Format | [KHz] | Duration [ms] | [ms] |
| 0 | 1.25 | 0.1031 | 0.0969 |
| 1 | 1.25 | 0.6848 | 0.7156 |
| 2 | 1.25 | 0.1526 | 0.9526 |
| 3 | 5 | 0.1031 | 0.0969 |
| 4 | 1.25 | 0.7988 = 24524κ × | 0.8143 = 24998κ × |
| | | 0.509 × 10⁻⁶ | 0.509 × 10⁻⁶ |
| . | . | . | . |
| . | . | . | . |
| . | . | . | . |

In NR, a 12 bits RAR message may be reserved for TA value in a NR legacy specification. A TA command (TA) value may be also to constrained by the SCS, ΔT_{TA}=(T_{A}−31)×16×64/2^{μ}, where μ=0,1,2, . . . 3, etc. However, the legacy TA values may be too small for NR NTN systems considering the maximum differential delay with larger SCS values. Therefore, for some NTN deployment scenarios, the TA value may need to be extended to greater than 12 bits.

To distinguish between UEs with, without GNSS or without enough GNSS coverage and accuracy in NR NTN, one method may be that the network configures one or more RO groups (i.e., more than one separated RACH configuration). One RO group (first RACH configuration) may be for a UE with GNSS information, and the other RO group may be for a UE without GNSS information, as shown in Error! Reference source not found. Each RO group may comprise one or more ROs which define a specific mapping with SSBs as described in the NR specification. The interval between two consecutive RO may be at least larger than twice the maximum differential delay within the cell/cell coverage. The interval between two consecutive ROs (or RO periodicity) for a distinct RO group may be different or the same. The network may explicitly indicate which RO group is for a UE with/without GNSS, for example, via configuration. However, if a network configures multiple RO groups and has no explicit indication which RO group may be used for a UE with/without GNSS, the UE may use the RO periodicity (an implicit indication for a UE with/without GNSS to choose RO group) to determine which RO group may be used for RACH transmission. Without GNSS, the estimation of TA or RTT may be challenging or impossible if there is no assistance information. A UE without GNSS (or without UE positioning information) may experience larger residual timing error than a UE with GNSS because the UE cannot pre-compensate the TA. Therefore, the start of a RAR monitoring window (i.e., ra-Response Window or msgB-Response Window) may be based on the broadcast common TA and other broadcast offset (e.g., the delay of feeder linker for transparent payload). Also, the RAR monitoring window (e.g., ra-ResponseWindow or msgB-Response Window) for a UE may to be extended for a UE without GNSS because the UE may need to monitor the RAR early (i.e., the start of RAR may only be based on the common TA).

A summary of an example solution may be described by features comprising for a UE without GNSS, the start of RAR may be based on the broadcast common TA as one of the factors/parameters for the estimation of the RTT (assume N_{TA,UE-specific}=0) without GNSS information. More specifically, the start of RAR may be determined by the estimated RTT. For regenerative payloads, RTT may be based only on the service link. However, RTT may be based on both the service link and the feeder link for transparent architecture. In other words, the common TA may cover the service link for regenerative architecture, but the common TA may consider both the service link and the feeder link for transparent architecture. The RAR window may be extended for UEs without GNSS.

Separated RO groups for a UE with/without GNSS may consume more time and frequency resources. Therefore, a shared RO for a UE with/without GNSS may be considered for a 4-step RACH procedure. In this option, a UE with/without GNSS may need to align the start of the RAR window because the network may not distinguish between the UEs that have GNSS availability and the UEs that do not have GNSS availability. Therefore, in the example, for both UEs with and without GNSS, the start of the RAR window may be based on the broadcast common TA and the UE with GNSS may not need to estimate the full RTT (or the UE specific TA). This is because the network may not distinguish which UE may be capable of GNSS or not at this stage, so all UEs assume the same start offset for RAR reception. Therefore, if an RO is shared with the UE without GNSS, more power consuming may occur for the UE with GNSS. In addition, a UE may report its GNSS capability or availability in msg3 to the network. (Note: where the availability means that a UE may be able to access and use GNSS information, but the UE may be without GNSS information for any number of reasons, for example the UE may be without GNSS information as the UE attempts to reach the network). Additionally, if the shared RO for a UE with/without GNSS, the (available) PRACH preamble in the RO may be partitioned into two or more groups, the first preamble group may be for a UE with GNSS and the second preamble group may be for a UE without GNSS. Thus, the network may distinguish between the UEs with and without GNSS information. Note: the partitioned preamble group may be applied for 2-step RACH msgA transmission. If a preamble is partitioned into multiple groups for the indication of a UE with GNSS capability and/or availability, the UE with GNSS may calculate its start of the RAR based on estimated RTT.

The UE behavior for a 4-step RACH procedure with multi-RO groups for a UE with/without GNSS may be described as follows: Step 0: the UE may detect an SSB, read SI for RACH configuration and the broadcast satellite ephemeris e.g., orbit, position of the satellite, common TA, etc.; Step 1: If there are two or more separate RACH configurations (e.g., two RO groups) the UE may select the proper RACH configuration (e.g. based on the network indication in the configuration) for msg1 transmission. If only one RACH RO group is configured, the UE with/without GNSS may transmit msg1 at the same RO group. More than one preamble partitions or groups may be used to indicate UE capability with or without GNSS. If multiple preamble groups are configured for UE with or without GNSS, the UE may indicate to the network/g.VB, the GNSS capability and availability via the chosen preamble partition or group. For example, preamble partition 1 or group 1 may indicate to gNB that UE has GNSS capability or availability. Preamble partition 2 or group 2 may indicate to gNB that UE has no GNSS capability or availability. Otherwise, UE may indicate to the network/gNB, the GNSS capability and availability via the chosen RO group in msg3. Step 2: upon receiving the RAR, the UE may apply a TA correction for the UE-based estimation. The UE specific TA may be compensated via TA command field in RAR. The start of RAR window may be based on RTT estimation and the estimate of UE-gNB RTT may be equal to the sum of the UE's TA and K_{mac}. For a UE without GNSS, the UE's initial TA may be set to the broadcast common TA. For a UE with GNSS, the UE may calculate the UE specific TA with the assist of UE GNSS position and satellite position acquired from satellite ephemeris and apply to the RO with shorter periodicity for RACH transmission. Step 3: Network receives msg3 and the UE may report its full TA value in msg3 if the UE has GNSS. In other words, the TA value may be sent in msg3 and UE with GNSS may set the full TA value, otherwise it is default set to zero. Step 4: If the contention resolution is received successfully by the UE, the 4-step RACH procedure may be completed. The UE behavior for 4-step RACH procedure with multi-RO groups is summarized in Error! Reference source not found . . .

The UE behavior for 2-step RACH procedure if multi-RO groups are configured for UE with/without GNSS are described as follows: Step 0: UE detect an SSB, read SI for RACH configuration and the broadcast position of the satellite, common TA, and the like; Step 1: If there are two separate RACH configurations (i.e. two RO groups) the UE may select the proper RACH configuration (e.g. based on the network indication) for msgA (including preamble and PUSCH). For example, a UE without GNSS may select the RACH configuration with a longer RO periodicity for msgA transmission. If only one RACH configuration is available, for a UE with/without GNSS, transmit msgA at the same RO. More than one preamble partition or group may be used to indicate UE capability with or without GNSS. If multiple preamble partitions or groups are configured for the UE with or without GNSS, the UE may indicate to the network/gNB the GNSS capability and availability via the chosen preamble group or partition. For example, preamble partition 1 or group 1 may indicate to a gNB that a UE has GNSS capability or availability. Preamble partition 2 or group 2 may indicate to the gNB that a UE has no GNSS capability or availability. Otherwise, UE may report its GNSS capability in PUSCH payload (in msgA) or DMRS port (e.g. mapping to the DMRS ports for UE with/without GNSS) to the network thus network may distinguish the UE capability and availability. For a UE with GNSS, the UE may estimate and apply the initial timing advance. Upon application of the initial timing advance, the UE may complete transmission of msgA. Therefore, the UE may provide the estimated UE specific TA in the PUSCH for network to know the value of full timing advance applied by the UE. However, for a UE without GNSS, the UE specific TA may not be given in the PUSCH payload. For this case, a network may estimate the propagation delay for the UE without GNSS; Step 2: If the UE successfully receives the contention resolution, the start of a msgB window may be based on RTT estimation and the estimate of a UE-gNB RTT may be equal to the sum of the UE's TA and Kmac. For the UE without GNSS, the UE's initial TA may be set to the broadcast common TA. For the UE with GNSS, the UE apply the TA correction for the UE-based estimation in msgB. For the UE without GNSS, the network may inform the UE a TA value in msgB. The UE behavior for a 2-step RACH procedure with multi-RO groups is summarized in Error! Reference source not found.

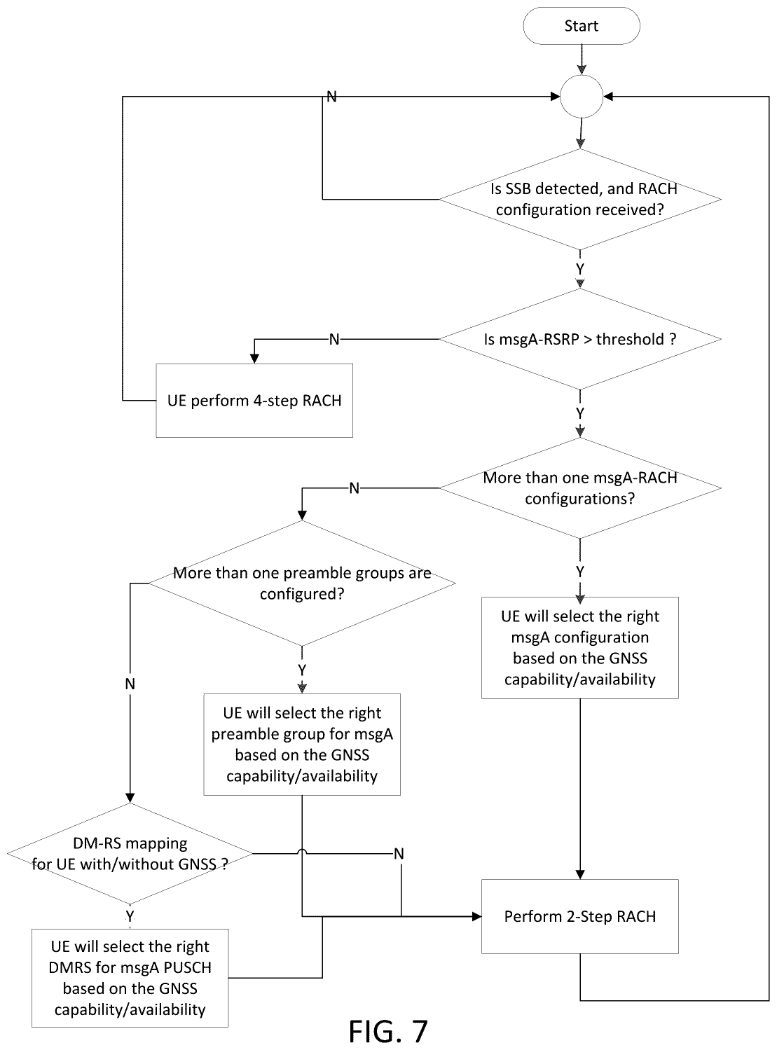

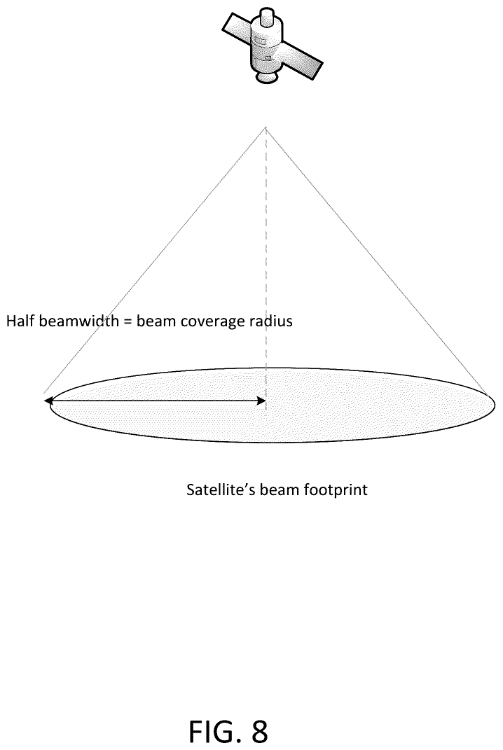

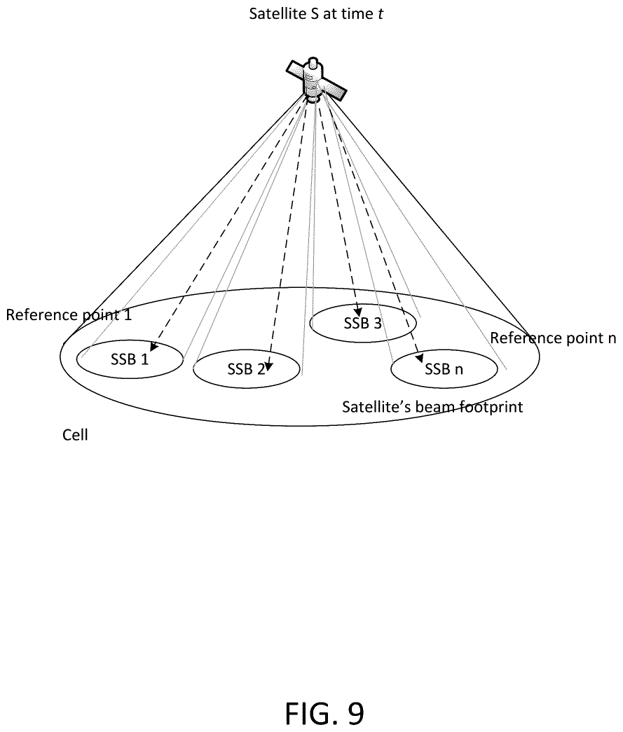

For example, the method described in FIG. 7 may comprise determining, by a WTRU, a lack of GNSS information associated with a NTN system. The method may further comprise determining a RACH transmission and a DMRS, wherein at least one of the RACH transmission and the DMRS indicates the WTRU lacks the GNSS information. The method may further comprise sending, to the NTN system, the RACH transmission. The method may further comprise receiving, from the NTN system, a response message. The method may further comprise establishing, based on the response message, a connection with the NTN system.

The method described in FIG. 7 may further comprise determining, based on determining the WTRU lacks GNSS information, that the WTRU lacks a capability to access the GNSS information associated with the NTN system. Additionally, or alternatively, the method described in FIG. 7 may comprise determining the WTRU has a capability to access the GNSS information associated with the NTN system, and wherein the GNSS information associated with the NTN system is unavailable for the WTRU to access.

The DMRS described in FIG. 7 may further comprise one or more DMRS ports. For example, the indication, by the DMRS, that the WTRU lacks the GNSS information may comprise mapping the indication that the WTRU lacks the GNSS information to at least one of the one or more DMRS ports.

The method described in FIG. 7 may further comprise transmitting, by a data payload associated with the WTRU, the indication that the WTRU lacks the GNSS information. For example, the data payload may further comprise a physical uplink shared channel (PUSCH) payload.

The response message described in FIG. 7 may further comprise a second step of a two-step RACH procedure.

The received response message described in FIG. 7 may further comprise receiving a TA value associated with the NTN, further comprising establishing the connection with the NTN system based at least in part on the TA value.

In one example, a common frequency offset may be broadcast for a UE without GNSS: Indication of common post-compensation frequency offset for Uplink may be needed for UE without GNSS. In addition, a UE specific frequency offset may be unicast or multicast via DCI (unicast on UE-specific DCI and multicast on group common DCI) or MAC for UE without GNSS including without GNSS capability or availability.

If CSI-RS/TRS is available for an NTN UE and if the GNSS is not available, or the UE does not have a capability to acquire GNSS, the UE may use CSI-RS/TRS for frequency and Doppler estimation. The availability of the CSI-RS/TRS may be broadcast via SIB if the UE is in an RRC_IDLE and/or RRC_INACTIVE state.

However, separated RO groups/RACH configuration for UEs with/without GNSS may consume more time and frequency resources. In addition, to accommodate a larger differential delay for a UE without GNSS, a new long PRACH format may be required. Other methods may be proposed to reduce the requirement for time and frequency resources. For example, Multi-beam per cell may reduce the maximum delay in NTN.

The beam footprint size may vary from hundreds of kilometers to thousands of kilometers in NTN. The footprint of a satellite as shown in Error! Reference source not found. may represent the ground area that the satellite's transponders offer coverage for and may determine the satellite diameter required to receive each transponder's signal.

If a satellite can form multi (-spot) beams per cell and each beam footprint may be constrained within a limit (e.g., 100 km footprint per beam), the maximum differential delay may be limited by the satellite footprint. For example, the maximum differential delay may be less than 0.65 ms for a LEO beam footprint of 100 km. In this deployment scenario, NR PRACH long format 1 may be fit without any modification.

An SSB may be associated with a satellite beam footprint, shown in Error! Reference source not found. Multiple (common) TAs, each associated with one or more SSBs, may be broadcast via SI in SIB and a UE may use the detected SSB to select one of the multiple common TA. For example, the maximum number of SSB's may be denoted as M for a serving cell, and for M common TA may be broadcast in SIB if SSB and common TA value is a one-to-one mapping. If a common TA value is mapped to a group of SSB, N common TA are mapped with M SSB (N<M). For example, N=M/2, a common TA may map to two SSBs.

Another example synchronization method comprises UE-specific TA estimation methods without GNSS. If the differential delay is known to the UE, the UE may estimate the UE specific TA (i.e. N_{TA,UE-specific}) factor in T_{TA}. In other words, the differential delay may be estimated if one or more of the following conditions are known to a UE: Range (d₁), where the range describes the geometric distance between NTN UE and the satellite. The reference (or minimum) distance do in a satellite (spot) beam coverage.

If the differential delay may be estimated by the UE, the UE may calculate the specific TA and apply it for pre-compensation of the RACH transmission even if the UE may be without GNSS signal and/or capability. In this way, the differential delay may be reduced, thus no NR specification impacts for NR PRACH (e.g. format) and the quantity of required bits for TA command. The estimated range (d₁) may be applied for regenerative and transparent architecture. For transparent architecture, a network may signal a common TA as two parts: the first part may be to cover the service link thus the minimum distance d₀ in a satellite (spot) beam coverage as shown in Error! Reference source not found. may be indicated from the first part of the common TA. The 2^{nd} part of the common TA may be used for indication of a feeder link. Thus, a RTT for transparent architecture may be equal to the sum of the first and the second part of the common TA. If only a single common TA is indicated by the network for transparent architecture, the UE may assume the the minimum distance d₀=½ common TA×c. Detail may be presented using TOA for UE-specific TA estimation if a UE is without GNSS.

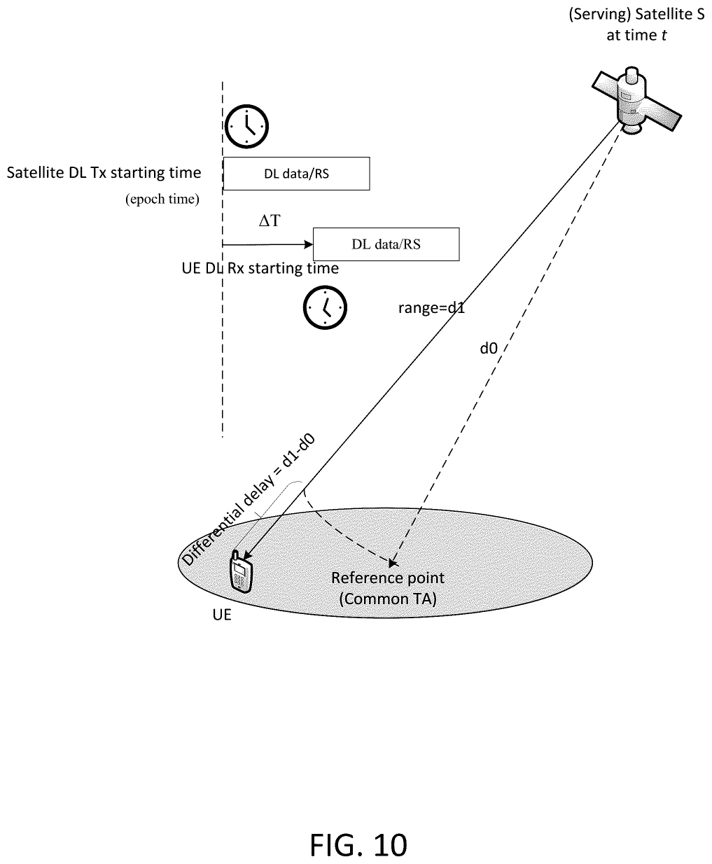

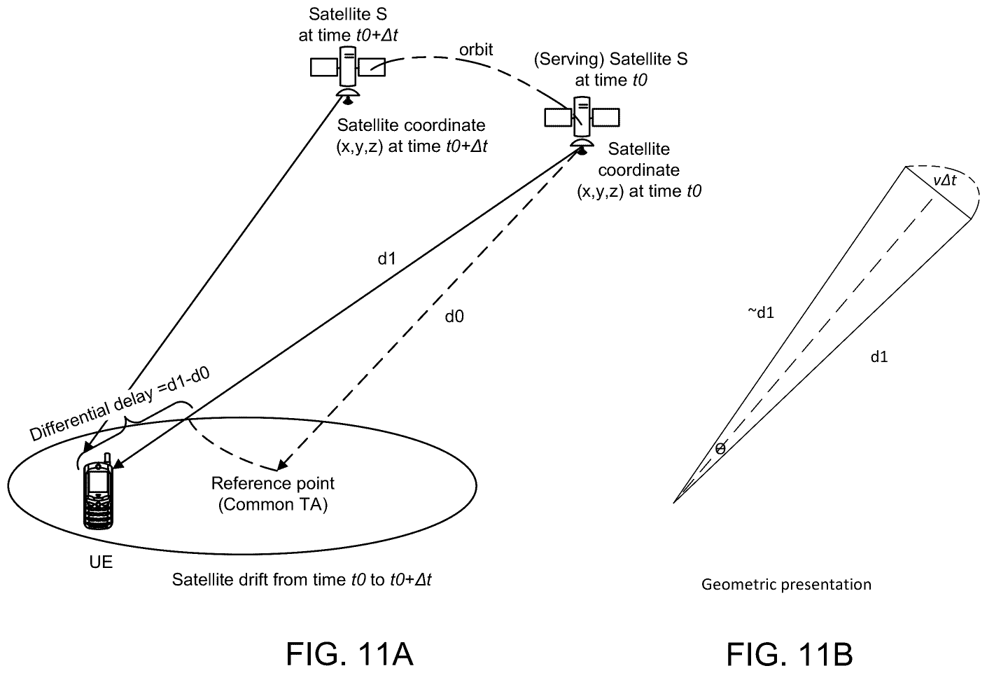

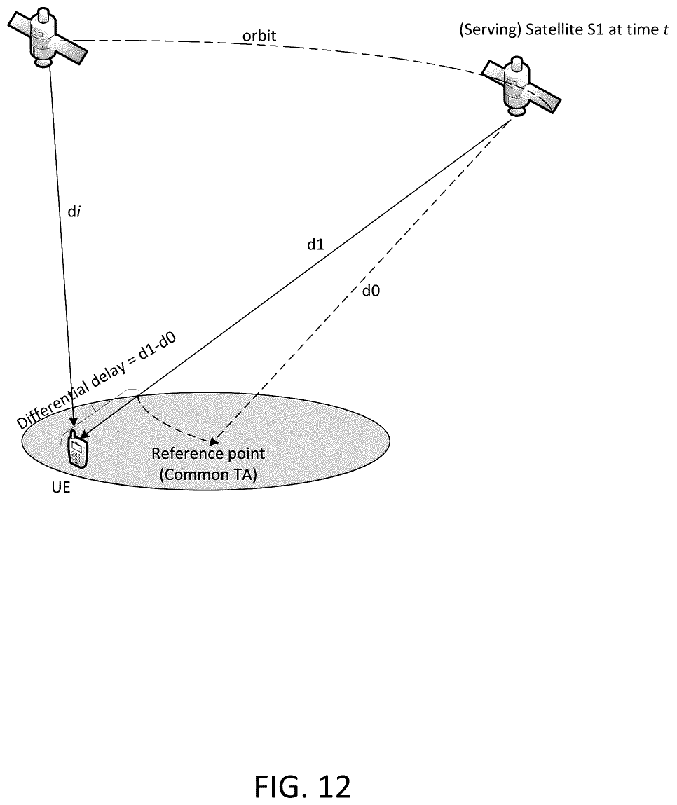

Another example solution comprises satellite range estimation via TOA. The range estimation using TOA is described, in one example, in FIG. 10. In this case, using one satellite may be sufficient for NTN UE to measure Downlink (DL) time of arrival (TOA). The TOA may be measured by the following equation: ΔT=Tᵣₓ−Tₜₓ+Tₑᵣᵣ, where Tᵣₓ is the receiver clock time when the signal is received, Tₜₓ is the transmit clock time when the signal is transmitted, Tₑᵣᵣ is the time error including the satellite and UE clock misalignment between the satellite and UE. ΔT is the measured TOA. The range di may be estimated via d1=cΔT where c denotes light speed. Note, Tₑᵣᵣ impacts the precision of range estimation. However, one of the goals for estimating the differential delay may be to reduce the RACH reception window and all NR PRACH formats may be reused. Therefore, the estimation may allow a certain degree of Tₑᵣᵣ and a TA margin may be defined if the TA is overestimated.

If the range information is available for a UE, the UE may compensate its UE specific TA for sending msgl or msgA, where the UE specific TA may be determined by d₁-d₀. For example, d₀ may be indicated by the common TA and the common TA may be determined by the distance between a reference point and the gNB for regenerative architecture.

A method for obtaining the transmit clock time Tₜₓ, is proposed as follows: the transmit clock time Tₜₓ may be broadcast as an assisted information along with the common TA. If the UE logs the time as Tᵣₓ as the UE receives the transmit clock time Tₜₓ (the satellite assistance information) from the satellite, the range d₁ may be estimated. Note: To ensure TOA working for range estimation, the clock both at the transmitter and receiver may need a certain degree of synchronization. For example, many smart phones have the capability to acquire GNSS, but smart phones may lose the GNSS availability in some scenarios (e.g., a smart phone is indoors), the clock of the smart phone may be still assumed well synchronized with the satellite (assume both are synchronized with the GNSS timing). The clock synchronization between the UE with GNSS capability and satellite may therefore still be valid. Therefore, it may be beneficial that an NTN system may broadcast the satellite transmission time Tₜₓ as part of satellite assistance information. Also, one of the goals for proposing using TOA for estimating the differential delay may be to reduce or minimize the RACH reception window and all NR PRACH formats may be reused. If RTT or (full) TA is overestimated is greater than a threshold, the UE may set the TA within the defined margin. For transparent payload/architecture, the satellite transmission time Tₜₓ may need to be adjusted because satellite transmission time Tₜₓ may not be embedded as a payload in the satellite. The following two methods for Tₜₓ adjustment may be considered: Tₜₓ is defined as the gNB transmission time and the feeder link propagation time is also broadcast along with the Tₜₓ, so the UE may deduct the feeder link propagation time as the true Tₜₓ. A gNB may pre-compensate the feeder link propagation time, therefore, Tₜₓ is the satellite transmit time.

Another example solution comprises estimating satellite range via satellite assistance data. Satellite moves at a speed/velocity v along with its orbit. Also, the epoch time may define the position of the orbiting body along the orbit at a specific time. Therefore, the UE may utilize the satellite ephemeris data and the satellite's moving speed/velocity to assist the estimation for the range d1. The range d₁ may be estimated with the following method: Step 1: UE obtains satellite position, velocity state vectors, and angular motion/speed at the epoch time t₀ from satellite broadcast data (e.g., SIB). The UE may start a validation time at the epoch time t₀. The UE may restart the validation timer until it receives the next available satellite ephemeris data. The range estimation may be done by the expiration of the validity timer. For example, the satellite position and velocity state vectors may be expressed as position X,Y,Z in ECEF (m) and velocity VX,VY, VZ in ECEF (m/s); Step 2: the UE may estimate the range as d₁ sinθ/2≈vΔt, where Δt is the delta time start from the epoch time t₀ as depicted in Error! Reference source not found. A and 0 is the span angle start from the epoch time t₀ as depicted in Error! Reference source not found.B. The span angle θ from [t₀, t₀+Δt] may be estimated from the product of the satellite (mean) angular motion/speed and Δt.

Another solution presented herein provides for a method for the UE to calculate the UE's position without GNSS, based at least in part on satellite positioning. Subject to the UE's capability, the UE may be responsible for calculating its own position by using DL reference signal (RS) with the satellite broadcasting its periodic ephemeris. With the UE location and satellite ephemeris information, the propagation delay between UE and the satellite may be estimated at the UE side. The UE may adjust the TA for its uplink transmissions for PRACH, PUSCH, etc. There are several positioning techniques such as DL/UL, time difference of arrival (TDOA), UL Angle-of-Arrival (AOA), and the like,. have been studied for Terrestrial Network (TN) in NR. For NTN positioning, there are several challenges compared to a similar TN, especially for a UE at RRC_IDLE/RRC_INACTIVE state. For example, lower received signal power, satellite drifting, and the like, in an NTN could impact the precision of estimated positioning. First, to assist an NTN UE without GNSS, the following DL RS may be used for UE positioning at RRC_IDLE and/or RRC_INACTIVE state: SSB, CSI-RS/TRS, PRS (Note: PRS may be used for UE at RRC_CONNECTED state), and DMRS (e.g. for PBCH, COREST #0, SIB PDSCH).

The UE positioning procedure in UE RRC_IDLE or RRC_INACTIVE state comprises one or more of: Step 1: the UE obtains satellite ephemeris information like position, velocity state vectors etc. at the epoch time from broadcast data (e.g. SIB) and the satellite (antenna) polarization assumption from SIB. Note: the same polarization may be same as the RS for the UE to calculate its position. For example, if PRS, CSI-RS/TRS, and the like are used for positioning calculation. The UE can assume those RS(s) are having the same polarization as the detected SSB and the (antenna) polarization assumption may be broadcast from SIB as noted in Rel-17. Once the UE has obtained new ephemeris data and polarization assumptions, the UE may start to look for configured DL RS for measurement and calculation of the satellite's position; Step 2: network may configure DL RS for the UE to perform the positioning measurement during the satellite ephemeris validation time. In other words, the network may ensure the availability of DL RS for the UE to perform positioning during the satellite ephemeris validity duration. Note: a validity duration configured by the network for satellite ephemeris data indicates the maximum time during which the UE may apply the satellite ephemeris without having acquired new satellite ephemeris. Once the UE position is calculated from DL RS, the UE may estimate its UE-specific TA like UE with GNSS. The availability of DL RS (e.g. CSI-RS/TRS, or PRS) for positioning may be indicated by SI/SIB for the UE in at least one of an RRC_IDLE state or RRC_INACTIVE state. Note: the network also may validate or indicate the availability for those RSs (e.g. PRS, CSI-RS, etc.) from the DCI/common PDCCH for paging channel. If more than one RS (e.g. PRS from non-serving NTN cells where are corresponding to other satellites) needs to be indicated, the availability information for configured RS resources may be via using a bitmap in SIB where each bit indicates whether associated PRS resource(s) are available. The network may configure a multiple of RS (e.g. PRS) and indicate the availability via a bitmap. The time duration of PRS configured by a higher layer may be a multiple duration of the satellite ephemeris validation time. In RCC_IDLE or RRC_INACTIVE state, reception of DL PRS has lower priority than other DL signals/channels like SSB, SIB1, CORESET0, msg2/msgB, paging, etc.; Step 3: the UE may apply the estimated UE-specific TA for UL transmission. The UE may indicate to the network/gNB in msg3/msgA that the UE-specific TA estimate may be based on non-GNSS positioning, or alternatively the positioning method(s) used, e.g., bitmap. Furthermore, for a 2-step RACH: the UE may indicate to the network/g.NB in msgA (e.g. PUSCH) for acquiring the positioning via using RS not from GNSS. In this way, the network can at least have knowledge of the GNSS availability of a UE.

In satellite positioning (e.g. TDOA), it may require involving multiple satellite ephemeris for the UE to calculate the position as shown in Error! Reference source not found. For TDOA positioning scheme, it requires at least three satellite locations and the corresponding measured TDOA for UE using the (3D) triangulation to calculate its position. For example, let ΔT_{i,s} denote the TDOA between a satellite i and the serving satellite s and the TDOA ΔT_{i,s} may be expressed as ΔT_{i,s}= (dᵢ−d₁)/c+(Tᵢ−Tₛ), where c denotes light speed, Ti denotes the transmit DL RS (e.g. PRS) time at the satellite i, Tₛ denotes the transmit DL RS (e.g. PRS) time at the serving satellite s, dᵢ=\sqrt{(xᵤ−xᵢ) 2+(yᵤ−yᵢ)2+(zᵤ−zᵢ)²} is the distance from UE to the satellite i and dₛ=\sqrt{(xᵤ−xₛ) 2+(yᵤ−yₛ)2+(zᵤ−zₛ)²} is the distance from UE to satellite s. Note: in practice, UE may assume NTN is synchronized so the transmission time is the same for all satellites, thus Tᵢ=Tₛ. Therefore, in practice, the ΔT_{i,s} may be simplified as ΔT_{i,s}=(dᵢ−d₁)/c. In addition, to support TDOA scheme, it may be crucial for the UE to obtain other non-serving satellites location (i.e., (xᵢ, yᵢ, zᵢ)) from the serving satellite.

The serving satellite may broadcast other satellite ephemeris information in SIB for the UE at RRC_IDLE/RRC_INACTIVE state. For UE at RRC_CONNECTED state, the network may either unicast or multicast other satellite ephemeris information via MAC, RRC or it may be pre-provisioned or via LPP messages.

The DL RS for positioning (e.g. PRS) may have one-to-one mapping with the broadcast satellite ephemeris or relative ephemeris in relation to the serving satellite ephemeris. For example, if the network configures M PRS, the M satellite ephemeris may be mapped/associated to each corresponding DL RS for positioning (e.g. PRS). In this way, the UE may obtain the locations of other satellites and the mapping to the DL RS for positioning.

Since several satellites typically share a common orbital plane in a satellite network, orbital plane parameters remain the same and may be pre-provisioned to the UE as baseline ephemeris data. Only satellite level parameters (e.g. satellite position X, Y,Z) are required to be broadcasted to the UE via system information thus the signaling overhead may be reduced. For example, the satellite velocity, drift rate, etc. may be omitted to reduce the signaling overhead.

Another solution may be provided herein for providing timing synchronization for NR NTN with multi-connectivity. In NR, dual connectivity (DC)-capable apparatus may perform a RACH procedure on both master-gNB (MgNB) and secondary-gNB (SgNB). Like in TN's, the UE may perform a RACH procedure on both MgNB and SgNB for an NTN with multi-connectivity (or DC). The following methods may provide synchronization for an NTN UE without GNSS and with MC. The UE may acquire its position from other connectivity (e.g. TN) to assist NTN UE without GNSS.

If the UE is with MC, (e.g., MgNB is TN and SgNB is NTN) and the UE is without GNSS capability and or availability (e.g., UE with GNSS signal degradation), the UE behavior for acquiring its position may be stated as follows: Step 1: the UE performs either 4-step or 2-step RACH procedure and the UE enters the RRC_CONNECTED state for requesting the UE positioning from TN; Step 2: Once the UE obtains the UE position from TN system, the UE performs: Step 2-1: the UE perform UE-specific TA estimation with the received satellite ephemeris information at the epoch time t₀, and Step 2-2: the UE performs a RACH procedure and indicates to the network that the UE position is provisioned from the TN; Step 3: the UE successfully receives contention resolution from the NTN gNB and the synchronization may be completed for NTN.

The other possible scenario may be that the TN may broadcast its cell coordinates and the UE may use the cell coordinates as the approximation as its UE coordinates if the UE is not far from a TN cell or Transmission and Reception Point (TRP). The (effective) differential delay or RACH reception window may be reduced so all legacy NR PRACH formats may be reused without any modification. For example, the satellite position may be expressed as position X, Y, Z in ECEF (m) as NTN. In practice, the UE may use the RSRP measurement (e.g. SSB) to validate whether using a TN cell/TRP coordinate or not. In addition, a gNB may broadcast or signal its cell/TRP coverage size for UE reference. Note: the signaling format for the indication of the cell/TRP coverage may use one or more of the following options: the true cell/TRP coverage size (e.g. in terms of km), and the categorized or quantized cell/TRP coverage size (e.g. if let value 0 indicates cell/TRP coverage size <=5 km, value 1 indicates 5 km<cell/TRP coverage size <=20 km, etc.).

Another possible scenario may be that the TN may relay the NTN for the UE (or called the indirect access in NTN). In this case, the UE may access the NTN through the TN network, thus the UE position may be not required for the NTN TA access. Furthermore, the TN network may configure some of DL/UL channels (e.g. PDSCH, PUSCH) with the specified timing synchronization information such as common TA, K_{offset} and K_{mac} for UE to adjust the reception or transmit timing with the DL/UL channels relayed from the NTN. If packet duplication (PD) where the same packets are sent from the different nodes (e.g. TN-NTN dual connectivity) is supported, then the latency between the TN and the NTN is different and the network may apply K_{offset} and K_{mac} for the TN link to algin the data arrive time for UE reception from both nodes (TN-NTN) at the same time. In this way, the UE can immediately process packets thus enhancing the reliability. Also, HARQ feedback timing may have the following options: 1) the HARQ feedback is on the TN link and the UE can transmit HARQ feedback without considering the extra K_{offset} and K_{mac} introduced from NTN. 2) the UE can transmit HARQ feedback with applying K_{offset} and K_{mac} which the HARQ feedback timing considers the NTN.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards comprise WCDMA (commonly referred as 3G), LTE (commonly referred as 4G), LTE-Advanced standards, and New Radio (NR), which may be also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cses with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive recall, disaster alerts, real-time gaming, multi-person video calls, autonomous driving, augmented reality, tactile internet, virtual reality, home automation, robotics, and aerial drones to name a few. All of these use cases and others are contemplated herein.

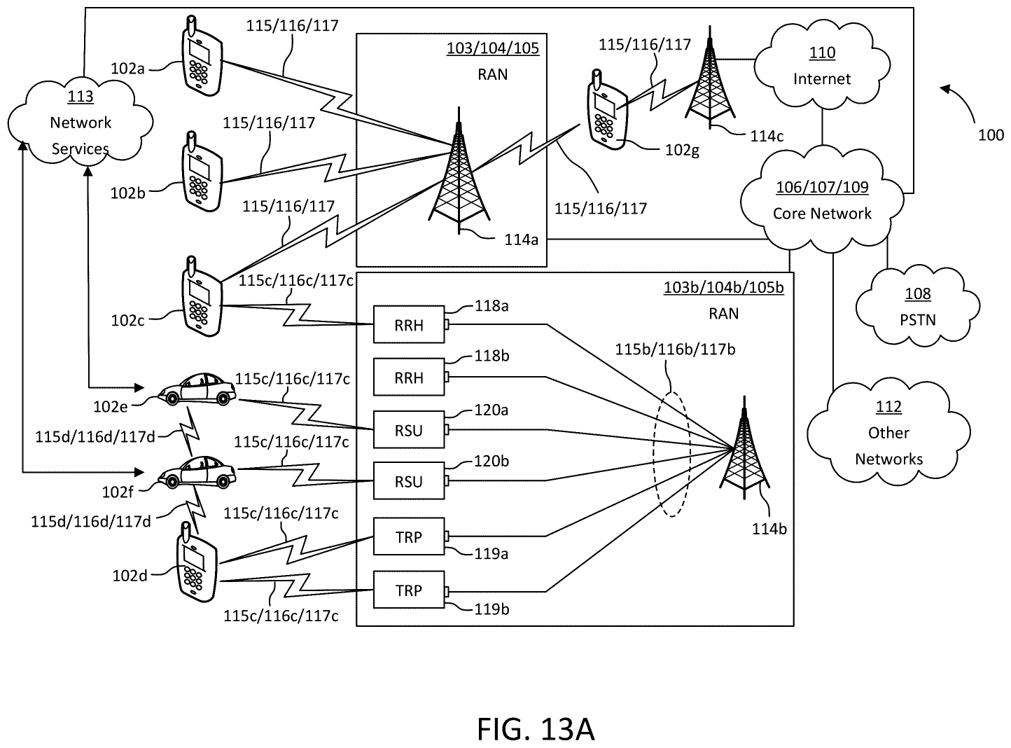

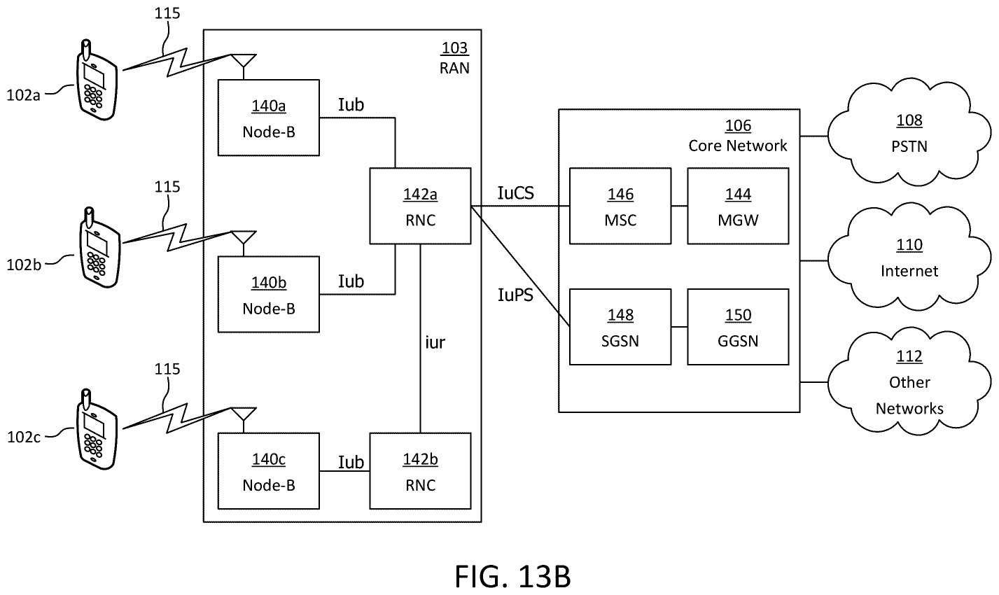

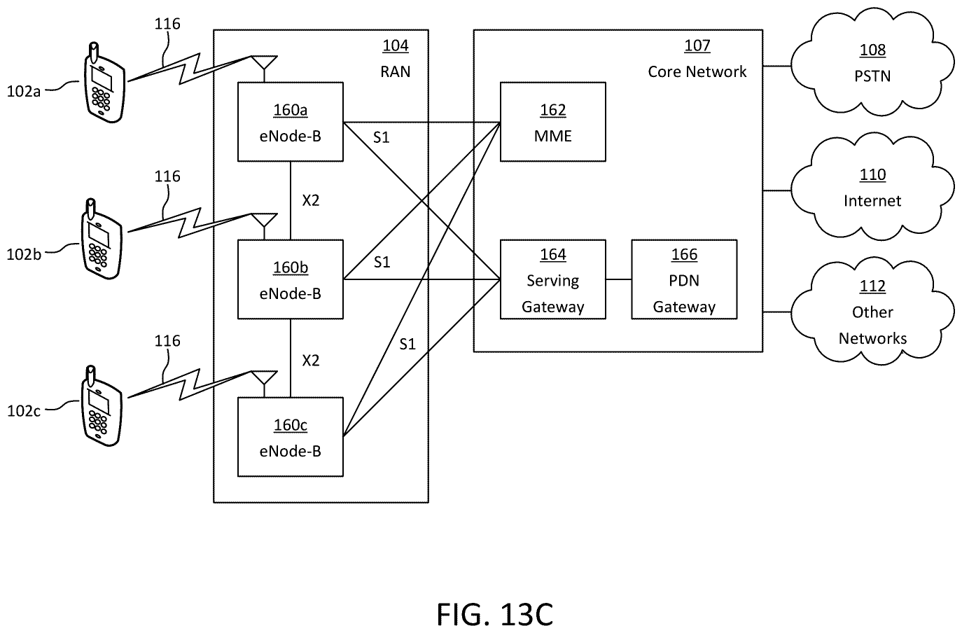

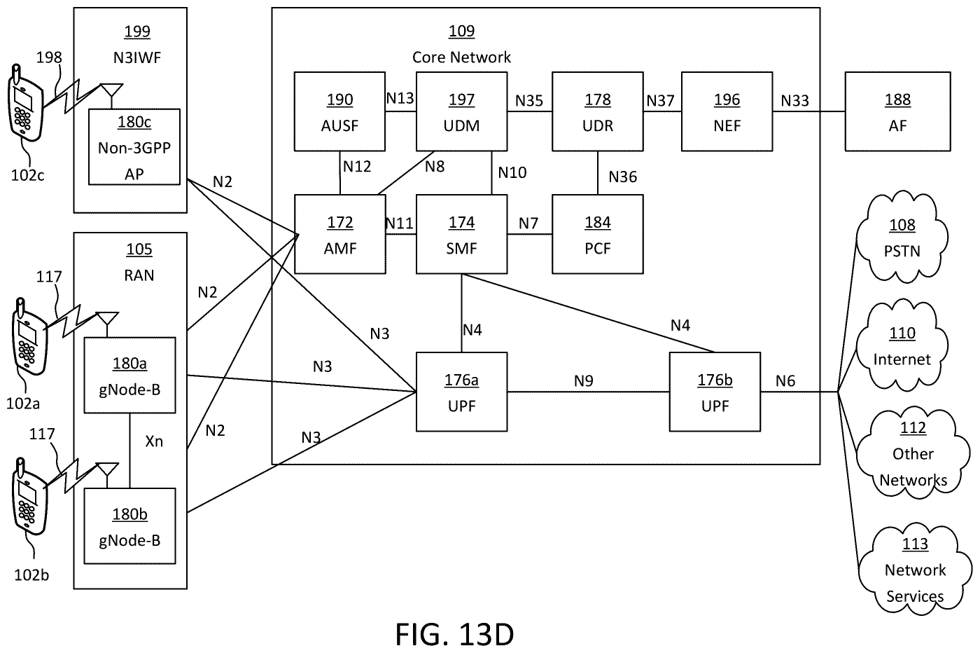

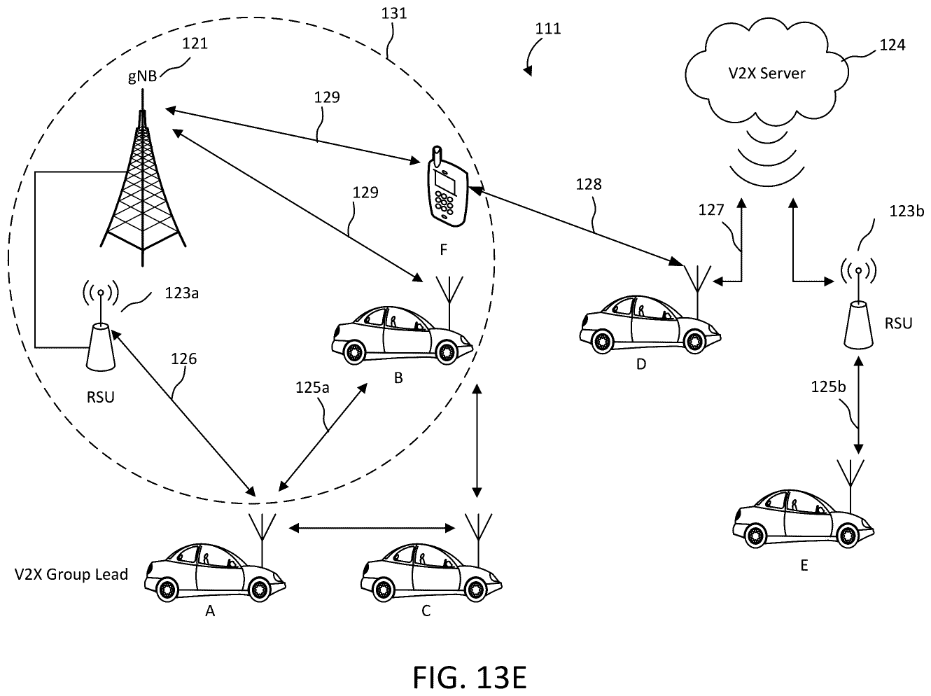

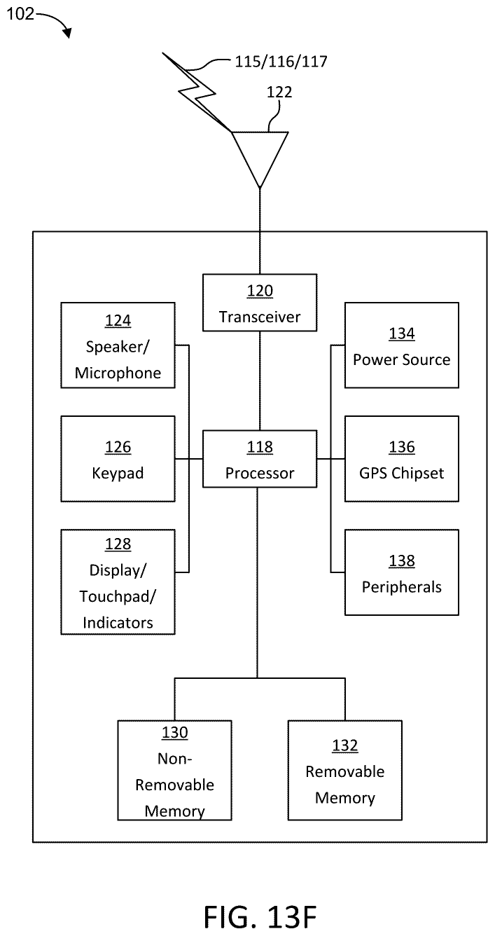

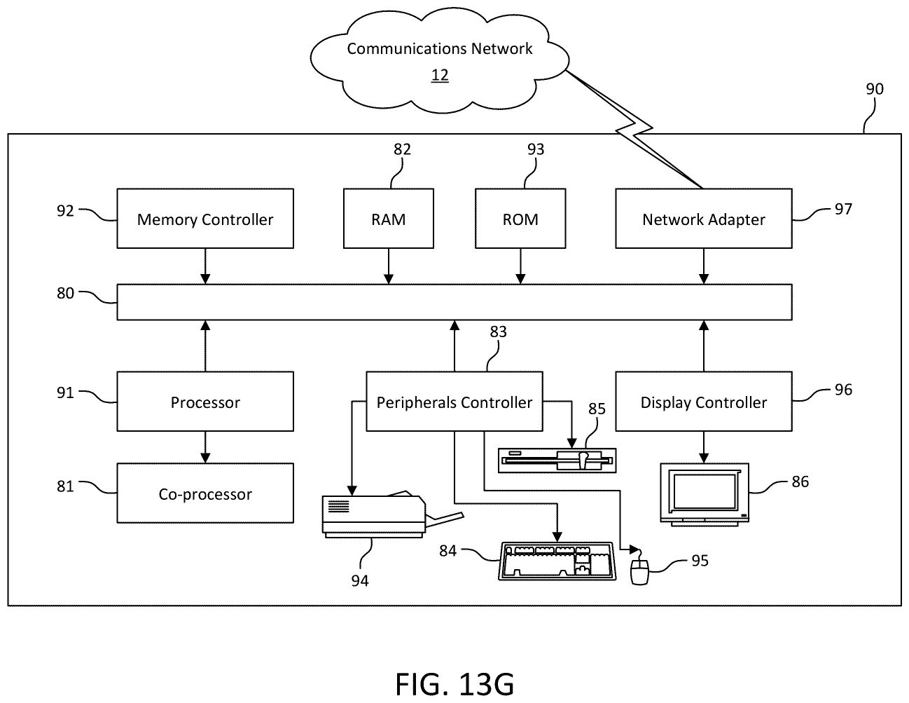

FIG. 13A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 13A, each of the WTRUs 102 is depicted in FIGS. 13A-13E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 13A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for example.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 13A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 13A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 13A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 13A may be configured to communicate with the base station 114a, which may employ a cellular-based radio technology, and with the base station 114c, which may employ an IEEE 802 radio technology.

Although not shown in FIG. 13A, it will be appreciated that a User Equipment may make a wired connection to a gateway. The gateway maybe a Residential Gateway (RG). The RG may provide connectivity to a Core Network 106/107/109. It will be appreciated that many of the ideas contemplated herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 13B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 13B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 13B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142aand 142b may be configured to carry out or support other functionality, such as outer loop power control, load control, admission control, packet scheduling, handover control, macro-diversity, security functions, data encryption, and the like.

The core network 106 shown in FIG. 13B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 13C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 13C, the eNode-Bs 160a, 160b, and 160c may communicate with one another over an X2 interface.

The core network 107 shown in FIG. 13C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RA.Ns (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-e Node B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 13D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and g Node-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 13D, the gNode-Bs 180a and 180b may communicate with one another over an Xn interface, for example.

The core network 109 shown in FIG. 13D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 13G.

In the example of FIG. 13D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 13D shows that network functions directly connect to one another, however, it should be appreciated that they may communicate via routing agents such as a diameter routing agent or message buses.

In the example of FIG. 13D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 13D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 13D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 13D, in a network slicing scenario, a WTRU 102a, 102b, or 102c may connect to an AMF 172, via an NI interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 13A, 13C, 13D, and 13E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 13A, 13B, 13C, 13D, and 13E are provided by way of example only, and it is understood that the subject matter disclosed and claimed herein may be embodied or implemented in any similar communication system, whether presently defined or defined in the future.

FIG. 13E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 13E, WTRUs B and F are shown within access network coverage 131. WTRUS A, B, C, D, E, and F may communicate with each other directly via a Sidelink interface (e.g., PC5 or NR PC5) such as interface 125a, 125b, or 128, whether they are under the access network coverage 131 or out of the access network coverage 131. For example, in the example of FIG. 13E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

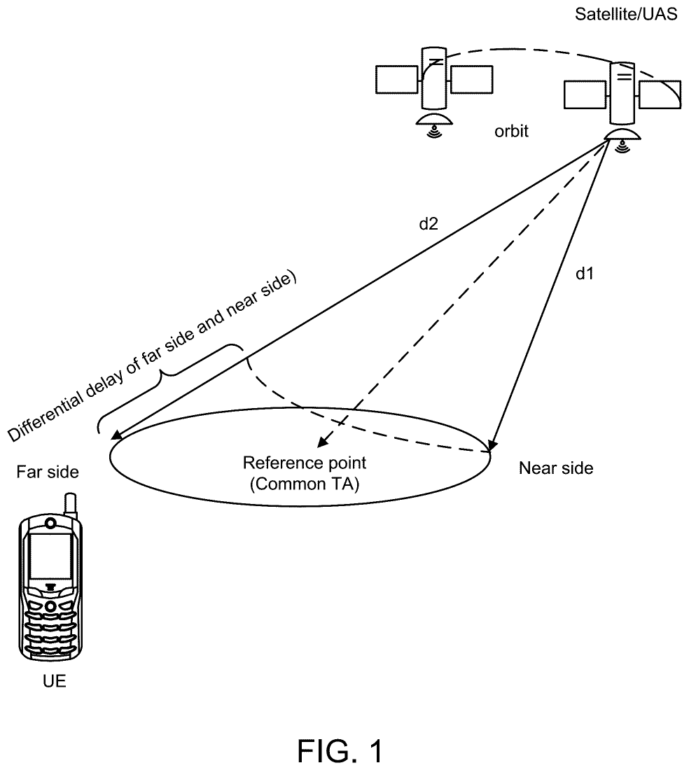

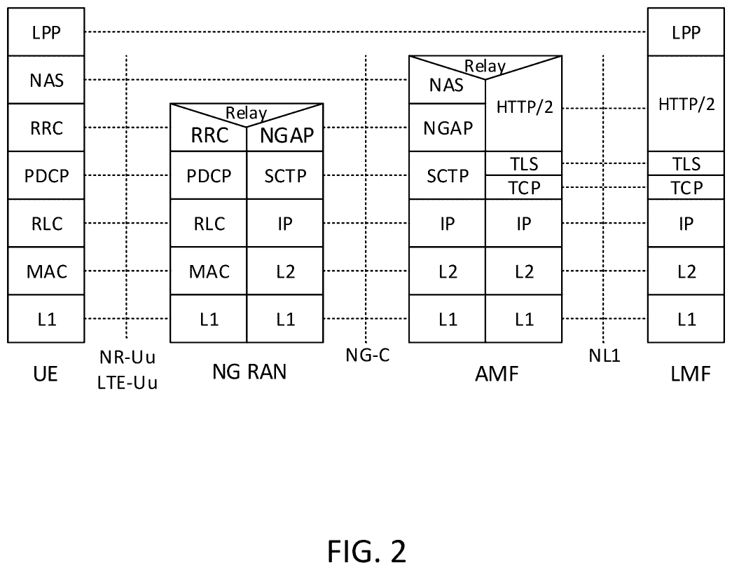

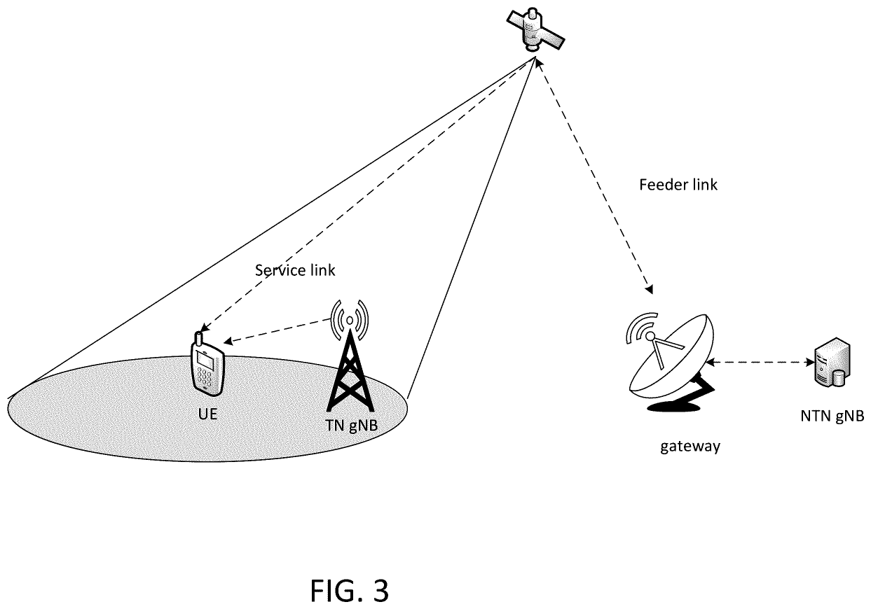

FIG. 13F is a block diagram of an example apparatus or device WTRU 102 that may be configured for wireless communications and operations in accordance with the systems, methods, and apparatuses described herein, such as a WTRU 102 of FIG. 13A, 13B, 13C, 13D, or 13E. As shown in FIG. 13F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 1F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 13F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 13A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 13F as a single element, the WTRU 102 may include any quantity of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 13G is a block diagram of an exemplary computing system 90 in which one or more apparatuses of the communications networks illustrated in FIGS. 13A, 13C, 13D, and 13E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to dowork. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 13A, 13B, 13C, 13D, and 13E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1-15. (canceled)

16. A method comprising:
determining, by a wireless transmit/receive unit (WTRU), a lack of global navigation satellite system (GNSS) information;
determining a random access channel (RACH) transmission and a demodulation reference signal (DMRS), wherein at least one of the RACH transmission and the DMRS indicates the WTRU lacks the GNSS information;
sending, to a non-terrestrial network (NTN) system, the RACH transmission;
receiving, from the NTN system, a response message; and
establishing, based on the response message, a connection with the NTN system.

17. The method of claim 16, wherein determining the WTRU lacks GNSS information comprises determining that the WTRU lacks a capability to access the GNSS information associated with the NTN system.

18. The method of claim 16, wherein determining the WTRU lacks GNSS information comprises determining that the WTRU has a capability to access the GNSS information associated with the NTN system, and wherein the GNSS information associated with the NTN system is unavailable for the WTRU to access.

19. The method of claim 16, wherein the DMRS comprises one or more DMRS ports, and wherein the indication, by the DMRS, that the WTRU lacks the GNSS information comprises mapping the indication that the WTRU lacks the GNSS information to at least one of the one or more DMRS ports.

20. The method of claim 16, further comprising transmitting a data payload that comprises the indication that the WTRU lacks the GNSS information.

21. The method of claim 20, wherein the data payload is transmitted in a physical uplink shared channel (PUSCH) transmission.

22. The method of claim 16, wherein the response message further comprises a second step of a two-step RACH procedure.

23. The method of claim 16, wherein receiving the response message further comprises receiving a timing advance (TA) value associated with the NTN, further comprising establishing the connection with the NTN system based at least in part on the TA value.

24. A wireless transmit/receive unit (WTRU) comprising:
a processor configured to:
determine a lack of global navigation satellite system (GNSS) information;
determine a random access channel (RACH) transmission and a demodulation reference signal (DMRS), wherein at least one of the RACH transmission and the DMRS indicates the WTRU lacks the GNSS information;
send, to a non-terrestrial network (NTN) system, the RACH transmission;
receive, from the NTN system, a response message; and
establish, based on the response message, a connection with the NTN system.

25. The WTRU of claim 24, wherein determining the WTRU lacks GNSS information comprises determining that the WTRU lacks a capability to access the GNSS information associated with the NTN system.

26. The WTRU of claim 24, wherein determining the WTRU lacks GNSS information comprises determining that the WTRU has a capability to access the GNSS information associated with the NTN system, and wherein the GNSS information associated with the NTN system is unavailable for the WTRU to access.

27. The WTRU of claim 24, wherein the processor is further configured to determine that the WTRU lacks the GNSS information based on a determination that the DMRS is mapped to a particular DMRS port of one or more DMRS ports.

28. The WTRU of claim 24, wherein the processor is further configured to transmit a data payload that comprises the indication that the WTRU lacks the GNSS information.

29. The WTRU of claim 28, wherein the data payload is transmitted in a physical uplink shared channel (PUSCH) transmission.

30. The WTRU of claim 24, wherein the response message further comprises a second step of a two-step RACH procedure.

31. The WTRU of claim 24, wherein the DMRS comprises one or more DMRS ports, and wherein the indication, by the DMRS, that the WTRU lacks the GNSS information comprises mapping the indication that the WTRU lacks the GNSS information to at least one of the one or more DMRS ports.

32. The WTRU of claim 24, wherein receiving the response message further comprises receiving a timing advance (TA) value associated with the NTN, wherein the processor is further configured to establish the connection with the NTN system based at least in part on the TA value.

33. The method of claim 16, wherein the DMRS comprises one or more DMRS ports, and wherein the method further comprises determining the WTRU lacks the GNSS information based on a determination that the DMRS is mapped to a particular DMRS port of one or more DMRS ports.

34. The method of claim 16, wherein the GNSS information is associated with the NTN system.

35. The WTRU of claim 24, wherein the GNSS information is associated with the NTN system.
